(19) United States
(12) Patent Application Publication
(10) Pub. No.: US 2022/0220420 A1
(43) Pub. Date: Jul. 14, 2022

(54) LAUNDRY COMPOSITION

(71) Applicant: Conopco, lnc., d/b/a UNILEVER, Englewood Cliffs, NJ (US)

(72) Inventors: Karl BURGESS, Prenton, Wirral (GB); Andrew Peter ROSE, Wrral (GB)

(73) Assignee: Conopco, lnc., d/b/a UNILEVER, Englewood Cliffs, NJ (US)

(21) Appl. No.: 17/610,023

(22) PCT Filed: Apr. 28, 2020
(86) PCT No.: PCT/EP2020/061718

§ 371 Date: Nov. 9, 2021

(30) Foreign Application Priority Data
May 16, 2019 (EP) 19174834.2

(51) Int. Cl. C11D 3/42; C11D 11/00; C11D 3/00; C11D 3/50

(52) U.S. Cl. CPC C11D 3/42; C11D 11/0017; C11D 3/505; C11D 3/0021; C11D 3/0036

(57) ABSTRACT

The present invention relates to an ancillary laundry composition for use in laundering white fabrics, the ancillary laundry composition comprising: a. 0.001 to 5 wt. % fluorescer, b. 0.5 to 12 wt. % non-ionic surfactant; and c. Water.

### FIELD OF THE INVENTION

The present invention relates to an ancillary laundry composition for providing benefits to white fabric.

### BACKGROUND OF THE INVENTION

Consumers traditionally separate their whites from their dark laundry, they are aware that washing a white shirt with black jeans may result in a grey shirt. However, once they have separated their washing, there is a shortage of products which are tailored to specific fabric types, and which are effective in providing specific benefits. Not only do consumers desire effective products, they also require products to be convenient to use.

Fluorescers are known to be useful in treating white fabrics. However, the inclusion of fluorescers in traditional laundry products is not always effective. In laundry detergents the degree of deposition can be low, leading poor results. In fabric conditioners, the use of fluorescers can have a negative impact on shelf life and performance and deposition can be uneven, leading to an unacceptable bright and dark patch on the fabric.

There is a need for a convenient and effect product, tailored to use with white fabrics, which overcomes some of the issues described here.

### SUMMARY OF THE INVENTION

In a first aspect of the present invention is provided an ancillary laundry composition for use in laundering white fabrics, the ancillary laundry composition comprising:
a. 0.001 to 5 wt. % fluorescer,
b. 0.5 to 12 wt. % non-ionic surfactant; and
c. Water.

In a second aspect of the present invention is provided a method of washing white fabrics, wherein an ancillary laundry composition comprising:
a. 0.001 to 5 wt. % fluorescer,
b. 0.5 to 12 wt. % non-ionic surfactant; and
c. Water.
   is added to the laundry process in addition to a laundry liquid or powder.

In a third aspect of the present invention is provided a use of an ancillary laundry composition comprising:
a. 0.001 to 5 wt. % fluorescer,
b. 0.5 to 12 wt. % non-ionic surfactant; and
c. Water.
   to maintain the whiteness of fabrics.

In a forth aspect of the present invention is provided a use of an ancillary laundry composition comprising:
a. 0.001 to 5 wt. % fluorescer,
b. 0.5 to 12 wt. % non-ionic surfactant; and
c. Water.
   to restore whiteness to white fabrics.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Form of the Invention

The term ‘ancillary laundry composition’ is used to refer to a specific format of laundry product. This is a liquid product which is intended to be used in addition to a laundry detergent and/or the fabric conditioner to provide an additional or improved benefit to the materials in the wash or rinse cycle. However, the formulations may also be used instead of a fabric conditioner formulation. Ancillary laundry compositions may also be referred to as a serum.

This particular format provides improved benefit delivery and also provides consumers with a simple additive product, which can be used in addition to their usual fabric conditioner when washing white fabrics.

Fluorescer

The ancillary laundry composition of the present invention comprises a fluorescer. Fluorescers may also be referred to as optical brighteners, optical brightening agents (OBAs), fluorescent brightening agents (FBAs), or fluorescent whitening agents (FWAs). These are chemical compounds that absorb light in the ultraviolet and violet region (usually 340-370 nm) of the electromagnetic spectrum, and re-emit light in the blue region (typically 420-470 nm) by fluorescence.

The ancillary laundry compositions of the present invention preferably comprise less than 5 wt. %, more preferably less than 2.5 wt. %, most preferably less than 1 wt. % fluorescer. The ancillary laundry compositions of the present invention preferably comprise more than 0.001 wt. %, more preferably more than 0.01 wt. % and most preferably more than 0.1 wt. % fluorescer. Suitably, the ancillary laundry compositions of the present invention preferably comprise 0.001 to 5 wt. %, more preferably 0.01 to 2.5 wt. % and most preferably 0.1 to 1 wt. % fluorescer.

Usually, these fluorescent agents are supplied and used in the form of their alkali metal salts, for example, the sodium salts.

Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra, Tinopal 5BMGX, and Blankophor (Trade Mark) HRH, and Pyrazoline compounds, e.g. Blankophor SN.

Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfoslyryl)biphenyl.

Non-Ionic Surfactant

The ancillary laundry composition of the present invention comprises non-ionic surfactant. The ancillary laundry compositions of the present invention preferably comprise less than 12 wt. %, more preferably less than 8 wt. % and most preferably less than 5 wt. % non-ionic surfactant. The ancillary laundry compositions of the present invention preferably comprise more than 0.5 wt. % non-ionic surfactant. Suitably, the ancillary laundry compositions of the present invention preferably comprise 0.5 to 12 wt. %, more preferably 0.5 to 8 wt. % and most preferably 0.5 to 5 wt. % non-ionic surfactant. The correct amount of non-ionic surfactant is important to achieve the desired delivery of the benefit agent. The ancillary laundry composition requires sufficient surfactant to carry the benefit agent, however too much surfactant will interfere with the action of the laundry liquid or powder with which it is used and will prevent release of the benefit agent due to insufficient dilution.

The non-ionic surfactants will preferably have an HLB value of 12 to 20, more preferably 14 to 18.

Examples of non-ionic surfactant materials include: ethoxylated materials, polyols such as polyhydric alcohols and polyol esters, alkyl polyglucosides, EO-PO block copolymers (Poloxamers). Preferably, the non-ionic surfactant is selected from ethoxylated materials.

Preferred ethoxylated materials include: fatty acid ethoxylates, fatty amine ethoxylates, fatty alcohol ethoxylates, nonylphenol ethoxylates, alkyl phenol ethoxylate, amide ethoxylates, Sorbitan(ol) ester ethoxylates, glyceride ethoxylates (castor oil or hydrogenated castor oil ethoxylates) and mixtures thereof.

More preferably, the non-ionic surfactant is selected from ethoxylated surfactants having a general formula:

R₁O(R₂O)ₓH

R₁=hydrophobic moiety.
R₂=C₂H₄ or mixture of C₂H₄ and C₃H₆ units
x=4 to 120

R1 preferably comprises 8 to 25 carbon atoms and mixtures thereof, more preferably 10 to 20 carbon atoms and mixtures thereof most preferably 12 to 18 carbon atoms and mixtures thereof. Preferably, R is selected from the group consisting of primary, secondary and branched chain saturated and/or unsaturated hydrocarbon groups comprising an alcohol, carboxy or phenolic group. Preferably R is a natural or synthetic alcohol.

R2 preferably comprises at least 50% C2H4, more preferably 75% C2H4, most preferably R2 is C2H4.

x is preferably 8 to 90 and most preferably 10 to 60.

Examples of commercially available, suitable non-ionic surfactants include: Genapol C200 ex. Clariant and Eumulgin CO40 ex. BASF.

Soil Release Polymer

The ancillary laundry compositions of the present invention preferably comprise soil release polymers. Soil release polymers (SRPs) help to improve the detachment of soils from fabric by modifying the fabric surface during washing. The adsorption of a SRP over the fabric surface is promoted by an affinity between the chemical structure of the SRP and the target fibre.

The ancillary laundry compositions of the present invention preferably comprise less than 30 wt. %, more preferably less than 18 wt. %, most preferably less than 5 wt. % soil release polymer. The ancillary laundry compositions of the present invention preferably comprise more than 0.5 wt. % soil release polymer. Suitably, the ancillary laundry compositions of the present invention preferably comprise 0.5 to 30 wt. %, more preferably 0.5 to 18 wt. % and most preferably 0.5 to 5 wt. % soil release polymer.

SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M_{w}) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate.

Other types of SRP for use in the invention include cellulosic derivatives such as hydroxyether cellulosic polymers, C₁-C₄alkylcelluloses and C₄ hydroxyalkyl celluloses; polymers with poly(vinyl ester) hydrophobic segments such as graft copolymers of poly(vinyl ester), for example C₁-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred SRPs for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (I):

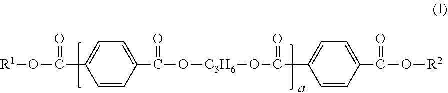

in which R¹ and R² independently of one another are X—(OC₂H₄)ₙ—(OC₃H₆)ₘ;
in which X is 01-4 alkyl and preferably methyl;
n is a number from 12 to 120, preferably from 40 to 50;
m is a number from 1 to 10, preferably from 1 to 7; and
a is a number from 4 to 9.

Because they are averages, m, n and a are not necessarily whole numbers for the polymer in bulk.

Mixtures of any of the above described materials may also be used.

The overall level of SRP, when included, may range from 0.1 to 10%, preferably from 0.3 to 7%, more preferably from 0.5 to 2% (by weight based on the total weight of the composition).

Suitable soil release polymers are described in greater detail in U.S. Pat. Nos. 5,574,179; 4,956,447; 4,861,512; 4,702,857, WO 2007/079850 and WO2016/005271.

A suitable soil release polymer for the present invention are commercially available as Texcare 260 ex. Clariant.

Dye Transfer Inhibitor

The ancillary laundry compositions of the present invention preferably comprise dye transfer inhibitors. The ancillary laundry compositions of the present invention preferably comprise less than 30 wt. %, more preferably less than 20 wt. %, most preferably less than 10 wt. % dye transfer inhibitor. The ancillary laundry compositions of the present invention preferably comprise more than 0.5 wt. % dye transfer inhibitor. Suitably, the ancillary laundry compositions of the present invention preferably comprise 0.5 to 30 wt. %, more preferably 0.5 to 20 wt. % and most preferably 0.5 to 10 wt. % dye transfer inhibitor.

The dye transfer inhibitor is more preferably selected from the group comprising polyvinyl pyrrolidone (PVP), polyvinyl imidazole (PVI), copolymers of vinyl pyrrolidone and vinyl imidazole (PVP/PVI), polyvinylpyridine-N oxide, poly-N-carboxymethyl-4-vinylpyridium chloride, polyethylene glycol-modified copolymers of vinyl pyrrolidone and vinyl imidazole, and mixtures thereof.

These compounds form particularly stable complexes with the dyes detached from the textiles and can also be easily incorporated in a stable manner into a liquid detergent or cleaning agent with a low content of water.

The dye transfer inhibitor is preferably a polymer or copolymer of cyclic amines, such as vinyl pyrrolidone and/or vinyl imidazole. As dye transfer inhibitor, suitable polymers include polyvinyl pyrrolidone (PVP), polyvinylimidazole (PVI), copolymers of vinyl pyrrolidone and vinyl imidazole (PVP/PVI), polyvinylpyridine-N-oxide, poly-N-carboxymethyl-4-vinylpyridium chloride, polyethylene glycol-modified copolymers of vinyl pyrrolidone and vinyl imidazole, and mixtures thereof. Polyvinyl pyrrolidone (PVP), polyvinylimidazole (PVI) or copolymers of vinyl pyrrolidone and vinyl imidazole (PVP/PVI) are particularly preferably used as dye transfer inhibitor. The used polyvinyl pyrrolidones (PVP) preferably have an average molecular weight from 2,500 to 400,000, and are commercially available from ISP Chemicals as PVP K 15, PVP K 30, PVP K 60 or PVP K 90, or from BASF as Sokalan® HP 50 or Sokalan® HP 53. The used copolymers of vinyl pyrrolidone and vinyl imidazole (PVP/PVI) preferably have a molecular weight in the range from 5,000 to 100,000. A PVP/PVI copolymer is commercially available by way of example from BASF under the name Sokalan® HP 56. A further dye transfer inhibitor that can be used in an extremely preferred manner is provided by polyethylene glycol-modified copolymers of vinyl pyrrolidone and vinyl imidazole, which for example are obtainable under the name Sokalan® HP 66 from BASF.

Shading Dye

The ancillary laundry compositions of the present invention preferably comprise a shading dye. Shading dye can be used to improve the performance of the compositions. Preferred dyes are violet or blue. It is believed that the deposition on fabrics of a low level of a dye of these shades, masks yellowing of fabrics. A further advantage of shading dyes is that they can be used to mask any yellow tint in the composition itself.

The ancillary laundry compositions of the present invention preferably comprise less than 0.01 wt. %, more preferably less than 0.005 wt. % shading dye. The ancillary laundry compositions of the present invention preferably comprise more than 0.0001 wt. %, preferably more than 0.0005 wt. % shading dye. Suitably, the ancillary laundry compositions of the present invention preferably comprise 0.0001 to 0.01 wt. %, more preferably 0.0005 to 0.005 wt. % shading dye.

Suitable and preferred classes of dyes are discussed below.

Direct Dyes:

Direct dyes (otherwise known as substantive dyes) are the class of water soluble dyes which have an affinity for fibres and are taken up directly. Direct violet and direct blue dyes are preferred.

Preferably bis-azo or tris-azo dyes are used.

Most preferably, the direct dye is a direct violet of the following structures:

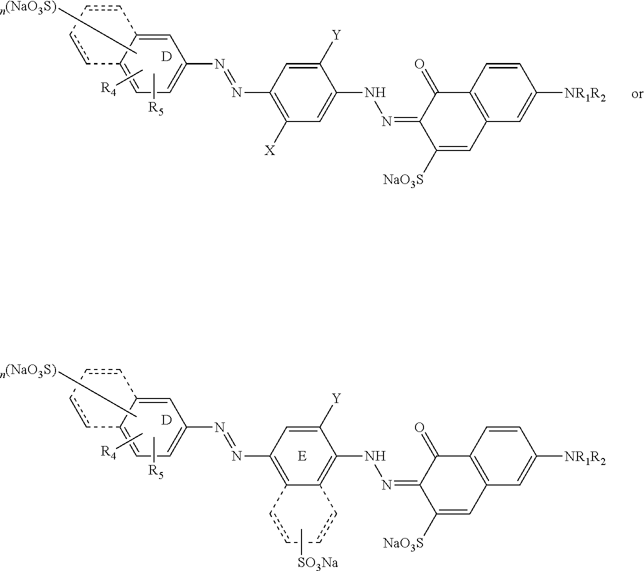

wherein:
ring D and E may be independently naphthyl or phenyl as shown;
R₁ is selected from: hydrogen and C₁-C₄-alkyl, preferably hydrogen;
R₂ is selected from: hydrogen, C₁-C₄-alkyl, substituted or unsubstituted phenyl and substituted or unsubstituted naphthyl, preferably phenyl;
R₃ and R₄ are independently selected from: hydrogen and C₁-C₄-alkyl, preferably hydrogen or methyl;
X and Y are independently selected from: hydrogen, C₁-C₄-alkyl and C₁-C₄-alkoxy; preferably the dye has X=methyl; and, Y=methoxy and n is 0, 1 or 2, preferably 1 or 2.

Preferred dyes are direct violet 7, direct violet 9, direct violet 11, direct violet 26, direct violet 31, direct violet 35, direct violet 40, direct violet 41, direct violet 51, and direct violet 99. Bis-azo copper containing dyes for example direct violet 66 may be used. The benzidene based dyes are less preferred.

In another embodiment the direct dye may be covalently linked to the photo-bleach, for example as described in WO2006/024612.

Acid Dyes:

Cotton substantive acid dyes give benefits to cotton containing garments. Preferred dyes and mixes of dyes are blue or violet. Preferred acid dyes are:

(i) azine dyes, wherein the dye is of the following core structure:

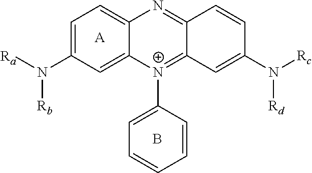

wherein Rₐ, R_{b}, R_{c} and R_{d} are selected from: H, a branched or linear C1 to C7-alkyl chain, benzyl a phenyl, and a naphthyl;
the dye is substituted with at least one SO₃⁻ or —COO⁻ group;
the B ring does not carry a negatively charged group or salt thereof; and
the A ring may further substituted to form a naphthyl; the dye is optionally substituted by groups selected from: amine, methyl, ethyl, hydroxyl, methoxy, ethoxy, phenoxy, Cl, Br, I, F, and NO₂.

Preferred azine dyes are: acid blue 98, acid violet 50, and acid blue 59, more preferably acid violet 50 and acid blue 98.

Other preferred non-azine acid dyes are acid violet 17, acid black 1 and acid blue 29.

Preferably the acid dye is present at 0.0005 wt % to 0.01 wt % of the formulation.

### Hydrophobic Dyes:

The composition may comprise one or more hydrophobic dyes selected from benzodifuranes, methine, triphenylmethanes, napthalimides, pyrazole, napthoquinone, anthraquinone and mono-azo or di-azo dye chromophores. Hydrophobic dyes are dyes which do not contain any charged water solubilising group. Hydrophobic dyes may be selected from the groups of disperse and solvent dyes. Blue and violet anthraquinone and mono-azo dye are preferred.

Preferred dyes include solvent violet 13, disperse violet 27 disperse violet 26, disperse violet 28, disperse violet 63 and disperse violet 77.

Preferably the hydrophobic dye is present at 0.0001 wt % to 0.005 wt % of the formulation.

Basic Dyes:

Basic dyes are organic dyes which carry a net positive charge. They deposit onto cotton. They are of particular utility for used in composition that contain predominantly cationic surfactants. Dyes may be selected from the basic violet and basic blue dyes listed in the Colour Index International.

Preferred examples include triarylmethane basic dyes, methane basic dye, anthraquinone basic dyes, basic blue 16, basic blue 65, basic blue 66, basic blue 67, basic blue 71,

basic blue 159, basic violet 19, basic violet 35, basic violet 38, basic violet 48; basic blue 3, basic blue 75, basic blue 95, basic blue 122, basic blue 124, basic blue 141.

Reactive Dyes:

Reactive dyes are dyes which contain an organic group capable of reacting with cellulose and linking the dye to cellulose with a covalent bond. They deposit onto cotton.

Preferably the reactive group is hydrolysed or reactive group of the dyes has been reacted with an organic species for example a polymer, so as to the link the dye to this species. Dyes may be selected from the reactive violet and reactive blue dyes listed in the Colour Index International.

Preferred examples include reactive blue 19, reactive blue 163, reactive blue 182 and reactive blue, reactive blue 96.

Dye Conjugates:

Dye conjugates are formed by binding direct, acid or basic dyes to polymers or particles via physical forces. Dependent on the choice of polymer or particle they deposit on cotton or synthetics. A description is given in WO2006/055787.

Particularly preferred dyes are: direct violet 7, direct violet 9, direct violet 11, direct violet 26, direct violet 31, direct violet 35, direct violet 40, direct violet 41, direct violet 51, direct violet 99, acid blue 98, acid violet 50, acid blue 59, acid violet 17, acid black 1, acid blue 29, solvent violet 13, disperse violet 27 disperse violet 26, disperse violet 28, disperse violet 63, disperse violet 77 and mixtures thereof.

Shading dye are especially preferred for use with the fluorescer of the present invention, in order to reduce yellowing due to chemical changes in adsorbed fluorescer.

Anti-Redeposition Polymers

The ancillary laundry compositions of the present invention may preferably comprise anti-redeposition polymers.

Anti-redeposition polymers stabilise the soil in the wash solution thus preventing redeposition of the soil. Suitable soil release polymers for use in the invention include alkoxylated polyethyleneimines. Polyethyleneimines are materials composed of ethylene imine units —CH2CH2NH— and, where branched, the hydrogen on the nitrogen is replaced by another chain of ethylene imine units. Preferred alkoxylated polyethyleneimines for use in the invention have a polyethyleneimine backbone of about 300 to about 10000 weight average molecular weight (Mw). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone.

Mixtures of any of the above described materials may also be used.

When included, a composition of the invention will preferably comprise from 0.25 to 8%, more preferably from 0.5 to 6% (by weight based on the total weight of the composition) of one or more anti-redeposition polymers such as, for example, the alkoxylated polyethyleneimines which are described above.

Perfumes

The ancillary laundry composition of the present invention preferably comprises perfume ingredients. Perfume ingredients may be provided either as a free oil and/or in a microcapsule.

The ancillary laundry composition of the present invention may comprise one or more perfume compositions. The perfume compositions may be in the form of a mixture of free perfumes compositions, a mixture of encapsulated perfume compositions or a mixture of encapsulated and free oil perfume compositions.

Preferably the ancillary laundry composition of the present invention comprise 0.5 to 20 w.t. % perfume ingredients, more preferably 1 to 15 w.t. % perfume ingredients, most preferably 2 to 10 w.t. % perfume ingredients.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume ingredients may be applied.

Free perfume may preferably be present in an amount from 0.01 to 20% by weight, more preferably 0.1 to 15%, more preferably from 0.1 to 10% by weight, even more preferably from 0.1 to 6.0%, most preferably from 0.5 to 6.0% by weight, based on the total weight of the ancillary laundry composition.

When perfume components are in a microcapsule, suitable encapsulating material, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume ingredients may be applied.

Encapsulated perfume may preferably be present in an amount from 0.01 to 20% by weight, more preferably 0.1 to 15%, more preferably from 0.1 to 10% by weight, even more preferably from 0.1 to 6.0%, most preferably from 0.5 to 6.0% by weight, based on the total weight of the ancillary laundry composition.

Structurant

If the ancillary laundry composition comprises microcapsules, a structurant may be required, non-limiting examples of suitable structurants include: pectine, alginate, arabinogalactan, carageenan, gellan gum, polysaccharides such as xanthum gum, guar gum, acrylates/acrylic polymers, water-swellable clays, fumed silicas, acrylate/aminoacrylate copolymers, and mixtures thereof.

Preferred dispersants herein include those selected from the group consisting of acrylate/acrylic polymers, gellan gum, fumed silicas, acrylate/aminoacrylate copolymers, water-swellable clays, polysaccharides such as xanthum gum and mixtures thereof. Most preferably the structurant is selected from polysaccharides such as xanthum gum, acrylate/acrylic polymers, acrylate/aminoacrylate copolymers, and water-swellable clays. Most preferred structurants are polysaccharides such as xanthum gum.

When present, a structurant is preferably present in an amount of 0.001-10 w.t. % percent, preferably from 0.005-5 w.t. %, more preferably 0.01-3 w.t. %.

Other Surfactants

The ancillary laundry composition of the present invention is not a traditional laundry detergent or fabric conditioning composition. The present invention preferably comprises low levels or no anionic or cationic surfactant.

The liquid ancillary composition of the present invention preferably comprises less than 2 w.t. % anionic and cationic surfactant, more preferably less than 1 w.t. % surfactant, even more preferably less than 0.85 w.t. % anionic and cationic surfactant and most preferably less than 0.5 w.t. % anionic and cationic surfactant.

The composition can be completely free of anionic and cationic surfactants.

In other words, the compositions preferably comprise 0 to 2 w.t. % anionic and cationic surfactant, more preferably, 0 to 1 w.t. % anionic and cationic surfactant, even more preferably 0 to 0.85 w.t. % and most preferably 0 to 0.5 w.t. % anionic and cationic surfactant. The composition can be completely free of anionic and cationic surfactant.

Rheology Modifier

In some embodiments of the present invention, the ancillary laundry composition of the present invention may comprise rheology modifiers. These may be inorganic or organic, polymeric or non polymeric. A preferred type of rheology modifiers are salts.

Preservatives

The ancillary laundry composition of the present invention preferably comprises preservatives. Preservatives are preferably present in an amount of 0.001 to 1 w.t. % of the composition. More Preferably 0.005 to 0.5 w.t %, most preferably 0.01 to 0.1 w.t. % of the composition.

Preservatives can include anti-microbial agents such as isothiazolinone-based chemicals (in particular isothiazol-3-one biocides) or glutaraldehyde-based products. Examples of suitable preservatives include Benzisothiazoline, Cloro-methyl-isothiazol-3-one, Methyl-isothiazol-3-one and mixtures thereof. Suitable preservatives are commercially available as Kathon CG ex. Dow and Proxel ex Lonza.

Other Ingredients

The products of the invention may further comprise other optional laundry ingredients known to the person skilled in the art, such as silicones, softening actives, antifoams, insect repellents, preservatives (e.g. bactericides), pH buffering agents, perfume carriers, hydrotropes, anti-redeposition agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers.

The compositions of the present invention are aqueous and comprise water.

Viscosity

The viscosity of the ancillary laundry composition is preferably 20-15000 mPa·s, more preferably 50 to 15000 mPa·s, most preferably 100 to 10000 mPa·s. This viscosity provides the benefit that the laundry liquid carries the ancillary laundry composition into the laundry process.

Throughout this specification viscosity measurements were carried out at 25° C., using a 4 cm diameter 2° cone and plate geometry on a DHR-2 rheometer ex. TA instruments.

In detail, all measurements were conducted using a TA-Instruments DHR-2 rheometer with a 4 cm diameter 2 degree angle cone and plate measuring system. The lower Peltier plate was used to control the temperature of the measurement to 25° C. The measurement protocol was a ‘flow curve’ where the applied shear stress is varied logarithmically from 0.01 Pa to 400 Pa with 10 measurement points per decade of stress. At each stress the shear strain rate is measured over the last 5 seconds of the 10 second period over which the stress is applied with the viscosity at that stress being calculated as the quotient of the shear stress and shear rate.

For those systems which exhibit a low shear viscosity plateau over large shear stress ranges, to at least 1 Pa, the characteristic viscosity is taken as being the viscosity at a shear stress of 0.3 Pa. For those systems where the viscosity response is shear thinning from low shear stress the characteristic viscosity is taken as being the viscosity at a shear rate of 21 s-1.

Preferably, the ancillary laundry composition floats on a, laundry liquid with which it is used. By float it is meant that the ancillary laundry composition will remain at the surface of the laundry liquid for a period of at least 5 minutes, preferably 10 minutes and most preferably at least 15 minutes. Floating provides the benefit the laundry liquid carries the ancillary laundry composition into the laundry process.

To enable the ancillary laundry composition to float, it is not essential that it is less dense than the laundry liquid with which it is being used, however it is preferred that the ancillary laundry composition is less dense than the laundry liquid with which it is used. This density provides the benefit the laundry liquid carries the ancillary laundry composition into the laundry process.

The ancillary laundry composition is preferably not miscible with a laundry liquid with which it is used. The in-admissibility prevents mixing of the ancillary laundry composition and laundry liquid and ensures maximum performance.

Method

In one aspect of the present invention is a method of washing white fabrics, wherein an ancillary laundry composition comprising:
a. 0.001 to 5 wt. % fluorescer,
b. 0.5 to 12 wt. % non-ionic surfactant; and
c. Water.
   is added to the laundry process in addition to a laundry liquid or powder. The ancillary laundry composition may be any composition described herein.

The compositions of the present invention may be used in a method for maintaining the white colour of white fabric or in a method of restoring the white colour of a fabric which has discoloured. One method of measuring the white maintenance benefit is the Granz-Griesser Whiteness Index.

In one preferred aspect of the present invention is a method of delivering the ancillary laundry composition into the wash or rinse stage, preferably the rinse.

A preferred method of delivering an ancillary laundry composition into the wash or rinse stage, comprises the steps of:
a. Pouring a laundry product into a washing receptacle, a washing machine drawer, or a dosing shuttle
b. Pouring a laundry ancillary laundry composition according to any preceding claim on top of the laundry product.

By washing receptacle, it is meant any vessel in which washing is performed. This may be for example the drum of a front or top loading washing machine or a bowl/sink in which hand washing is performed.

By drawer it as meant any one of the compartments in the washing machine drawer.

By dosing ball is meant any form of container which would usually hold a laundry detergent composition and be placed directly in a washing machine. By laundry product it is meant a detergent or fabric conditioning composition.

Preferably a laundry product is poured into a washing machine drawer or a dosing ball, and then the ancillary laundry composition is poured on top of the laundry product in the drawer or dosing ball.

Pouring the ancillary laundry composition on top of the laundry product provides the benefit that the laundry liquid carries the ancillary laundry composition into the wash or rinse without mixing with the two compositions.

Alternatively, the ancillary laundry composition may be added to the wash separately to any other laundry products being used in the wash process. e.g. at a different stage, in a separate compartment of a washing machine drawer, in a separate dosing ball etc. Alternatively, the ancillary laundry composition maybe used instead of a fabric conditioner.

Preferably the ancillary laundry composition is added to the laundry process in a volume of 2-50 ml, more preferably a volume of ml 2-30 ml, most preferably 2-20 ml. This dose is typically used with a 4-8 kg load of fabric, preferably and 5-6 kg load of fabric.

Use of the Composition

The ancillary laundry composition of the present invention may be used for white fabrics. One method of measuring the white benefits is the Granz-Griesser Whiteness Index. This index is known in the art and is defined to be used with D65/10 and reference wavelength 470 nm, the formula the index is calculated with is as follows:

$${W}_{Ganz} = Y - 1868.322 \times + - 3695.690 y + 1809.441$$

When maintenance of the white colour of a fabric is desired, preferably the differences between the pre-washed and post-washed white fabrics is less than −10 units, more preferably, less than −5 units. Preferably after 5 laundry cycles, using the ancillary laundry composition the differences between the pre-washed (at the start of the 5 cycles) and post-washed (at the end of the 5 cycles) white fabrics is less than −10 units, more preferably, less than −5 units.

When the composition is used to restore the whiteness of clothes, preferably the differences between the pre-washed and post-washed white fabrics is more than +5 units, more preferably, more than +10 units. This effect may be apparent after 5 or 10 laundry cycles in which the ancillary laundry composition is used.

When maintenance of whit fabrics is required a lower dosage of fluorescer is need in the laundry cycle than when restoration of white clothes which have discoloured over time is required. This can either be achieved by using a greater or lesser amount of fluorescer in the ancillary laundry compositions or a smaller or larger dose of the ancillary laundry composition. For example, a 10 ml dose may provide maintenance of whiteness, whereas a 20 ml dose provides restoration. Alternatively, an ancillary laundry composition comprising 0.1 wt. % fluorescer may provide maintenance of whiteness, whereas an ancillary laundry composition comprising 1 wt. % fluorescer may provide restoration.

Example Compositions

TABLE 1
Example compositions of the present invention

| Ingredient | 1 (wt. %) | 2 (wt. %) |
|---|---|---|
| Non-ionic surfactant ¹ | 4 | 6 |
| Flourescer ² | 0.7 | 0.3 |
| Free perfume | 10 | 8 |
| Encapsulated perfume | — | 2 |
| Soil release polymer ³ | — | 2.5 |
| Dye transfer inhibitor ⁴ | — | 2.5 |
| Shading dye ⁵ | — | 0.001 |
| Water | To 100 | To 100 |

Non-ionic surfactant ¹ Eumulgin CO40 ex. BASF
Flourescer ² Tinopal CBS-X ex. BASF
Soil release polymer ³ Texcare 260 ex. Clariant
Dye transfer inhibitor ⁴ Sokalan(R) HP 56 ex. BASF
Shading dye ⁵ Acid violet 50

These compositions provide witness maintenance benefits to white fabrics.

1) An ancillary laundry composition for use in laundering white fabrics, the ancillary laundry composition comprising:
a. 0.001 to 5 wt. % fluorescer,
b. 0.5 to 12 wt. % non-ionic surfactant; and
c. water;
wherein the composition comprises less than 2 wt. % surfactant selected from anionic, cationic and mixtures thereof.

2) The ancillary laundry composition according to claim 1, wherein the ancillary laundry composition further comprises soil release polymer.

3) The ancillary laundry composition according to claim 1, wherein the ancillary laundry composition further comprises dye transfer inhibitor.

4) The ancillary laundry composition according to claim 1, wherein the ancillary laundry composition further comprises shading dye.

5) The ancillary laundry composition according to claim 1, wherein the ancillary laundry composition further comprises 0.5 to 20 wt. % perfume ingredients.

6) The ancillary laundry composition according to claim 5, wherein the perfume ingredients comprise free perfume.

7) The ancillary laundry composition according to claim 5, wherein the perfume ingredients comprise encapsulated perfume.

8) The ancillary laundry composition according to claim 1, wherein the non-ionic surfactant comprises an ethoxylated non-ionic surfactant.

9) The ancillary laundry composition according to claim 1, wherein the viscosity of the ancillary laundry composition is 20-15000 mPa·s.

10) The ancillary laundry composition according to claim 1, wherein the composition comprises a structurant.

11) A method of washing white fabrics, wherein an ancillary laundry composition comprising:
a. 0.001 to 5 wt. Flo fluorescer,
b. 0.5 to 12 wt. % non-ionic surfactant; and
c. water
is added to a laundry process in addition to a laundry liquid or powder.

12) The method according to claim 11, wherein the ancillary laundry composition further comprises shading dye and perfume.

13) The method according to claim 11, wherein the ancillary laundry composition is added to the laundry process during a rinse stage of the laundry process.

14) The method according to claim 11 wherein the ancillary laundry composition maintains whiteness of fabrics it contacts.

15) The method according to claim 11 wherein the ancillary laundry composition restores whiteness to white fabrics it contacts.
